(19) United States
(12) Patent Application Publication
(10) Pub. No.: US 2018/0126457 A1
(43) Pub. Date: May 10, 2018

(54) ALUMINUM ALLOY POWDER AND MANUFACTURING METHOD OF ALUMINUM ALLOY OBJECT

(71) Applicant: INDUSTRIAL TECHNOLOGY RESEARCH INSTITUTE, Hsinchu (TW)

(72) Inventors: Yen-Yu HOU, Tainan City (TW); Chih-Chao YANG, Tainan City (TW); Ching-Chang HSIEH, Tainan City (TW); Chao-Ming CHEN, Chaozhou Township (TW); Chi-San CHEN, Kaohsiung City (TW)

(73) Assignee: INDUSTRIAL TECHNOLOGY RESEARCH INSTITUTE, Hsinchu (TW)

(21) Appl. No.: 15/392,365

(22) Filed: Dec. 28, 2016

(30) Foreign Application Priority Data
Nov. 10, 2016 (TW) 105136650

(51) Int. Cl. B22F 3/105; B22F 9/08; B22F 3/10; C22F 1/043; C22C 21/02; B33Y 10/00; B33Y 40/00; B33Y 70/00

(52) U.S. Cl. CPC B22F 3/1055; B22F 9/082; B22F 3/1017; C22F 1/043; C22C 21/02; B33Y 10/00; B22F 2009/084; B33Y 70/00; B22F 2998/10; B22F 2301/052; B22F 2009/0848; B22F 2009/0836; B22F 2009/0844; B33Y 40/00

(57) ABSTRACT

An aluminum alloy powder and a manufacturing method of an aluminum alloy object are provided. The aluminum alloy powder includes 96.5-99 wt % of a combination of Al, Si, Cu and Mg and the remainder including Ni and Mn. Moreover, the aluminum alloy powder includes an alloy core and a native oxide layer covering the alloy core.

This application claims the benefit of Taiwan application Serial No. 105136650, filed Nov. 10, 2016, the subject matter of which is incorporated herein by reference.

### TECHNICAL FIELD

The present disclosure relates to an aluminum alloy powder and a manufacturing method of an aluminum alloy object.

### BACKGROUND

Major industry countries in the world have proposed to achieve a goal of automobile fuel efficiency of 20 km/L or higher by the year of 2020; therefore weight reduction of vehicle bodies has become one of the important developing items. The weight percentage of the engine of a vehicle is only less than that of the vehicle body, thus if aluminum alloy is used to replace the currently-used iron-casting material of the engine, every 10% of weight reduction can increase 7% of fuel efficiency. As such, international vehicle and motorcycle companies all put efforts in developments of light-weighted aluminum alloy turbine engines hoping to replace the steel material by aluminum alloy material and make aluminum alloy the mainstream of the engine material in the next generation.

However, engines are for long-term operations, such that the operating temperature of the interior cylinder body will achieve 250° C. or ever higher, and the temperatures of the exhaust gas manifold and the turbine body will further exceed 400° C.; despite the cooling water routes in the engine interior, such high-temperature condition is still quite crucial to the current aluminum alloy materials, as such, destruction of materials, deformation or creeping may occur easily. Therefore, in the developments of light-weighted engines made fully of aluminum alloy, it is desirable to increase high-temperature mechanical properties of aluminum alloy materials.

### SUMMARY

The present disclosure relates to an aluminum alloy powder and a manufacturing method of an aluminum alloy object.

One embodiment of the present disclosure provides an aluminum alloy powder. The aluminum alloy powder includes 96.5-99 wt % of a combination of aluminum (Al), silicon (Si), copper (Cu) and magnesium (Mg) and the remainder including nickel (Ni) and manganese (Mn). Moreover, the aluminum alloy powder includes an alloy core and a native oxide layer covering the alloy core.

Another embodiment of the present disclosure provides a manufacturing method of an aluminum alloy object. The manufacturing method of the aluminum alloy object includes the following steps: providing an aluminum alloy composition, which includes 96.5-99 wt % of a combination of aluminum (Al), silicon (Si), copper (Cu) and magnesium (Mg); and the remainder including nickel (Ni) and manganese (Mn); performing a gas atomization process on the aluminum alloy composition for forming a plurality of aluminum alloy powders, each of the aluminum alloy powders including an alloy core and a native oxide layer covering the alloy core; performing a heating treatment on the aluminum alloy powders; and performing a laser additive manufacturing (AM) process on the aluminum alloy powders for forming an aluminum alloy object.

The following description is made with reference to the accompanying drawings and embodiments.

### BRIEF DESCRIPTION OF THE DRAWINGS

FIG. 1 shows a schematic drawing of an aluminum alloy powder according to an embodiment of the present disclosure;

FIGS. 2-3 show a laser additive manufacturing process according to an embodiment of the present disclosure; and

FIGS. 4A-4C respectively show average particle diameters (D₅₀) of aluminum alloy powders of embodiments 1-3 formed by gas atomization processes.

### DETAILED DESCRIPTION

In the embodiments of the present disclosure, the aluminum alloy powder includes an alloy core and a native oxide layer covering the alloy core, such that when the native oxide layer is crushed by the high energy laser from the laser additive manufacturing process, the oxide debris of the native oxide layer is uniformly distributed within the microstructure of the aluminum alloy object, such that the structure of the aluminum alloy object can be effectively strengthened. Details of embodiments of the present disclosure are described hereinafter with accompanying drawings. Specific structures and compositions disclosed in the embodiments are for examples and for explaining the disclosure only and are not to be construed as limitations. A person having ordinary skill in the art may modify or change corresponding structures and compositions of the embodiments according to actual applications.

According to the embodiments of the present disclosure, an aluminum alloy powder is provided. According to the embodiments of the present disclosure, the aluminum alloy powder can be used in manufacturing an aluminum alloy object. Further, according to the embodiments of the present disclosure, the aluminum alloy powder made by a gas atomization process can be used in manufacturing an aluminum alloy object.

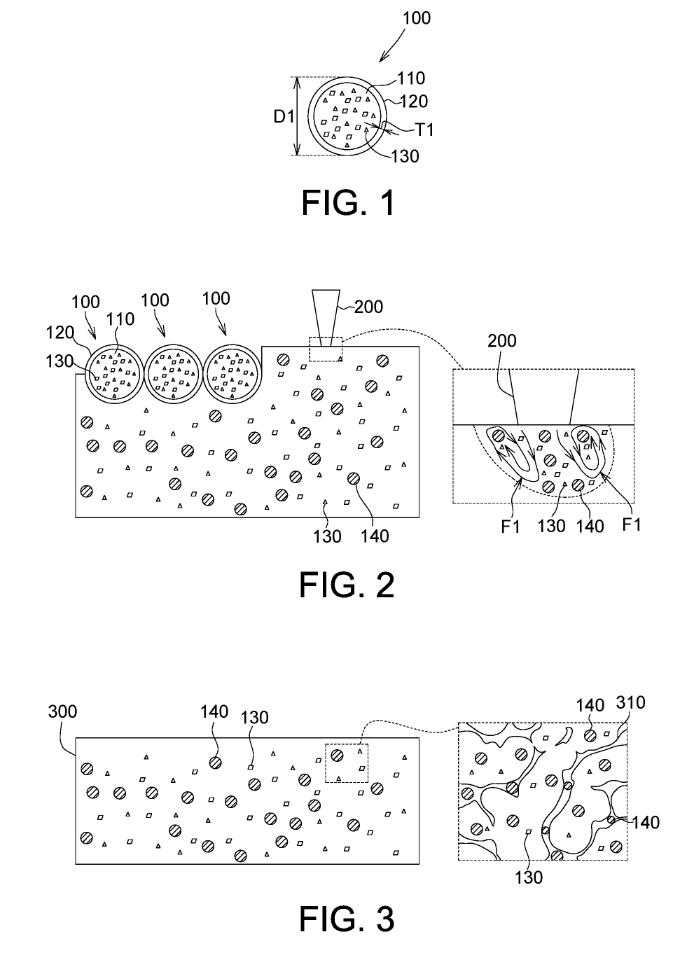

FIG. 1 shows a schematic drawing of an aluminum alloy powder according to an embodiment of the present disclosure. The composition of the aluminum alloy powder includes 96.5-99 wt % of a combination of aluminum (Al), silicon (Si), copper (Cu) and magnesium (Mg) and the remainder including nickel (Ni) and manganese (Mn). That is, in the aluminum alloy powder of the embodiments, in addition to the combination of Al, Si, Cu and Mg with the above-mentioned weight percentages, the remainder may include substantially Ni, Mn and other optional trace elements.

As shown in FIG. 1, the aluminum alloy powder 100 includes an alloy core 110 and a native oxide layer 120 covering the alloy core 110. The native oxide layer 120 is in fact formed on the surface of the powder by the oxidation of the alloy composition of the aluminum alloy powder. That is, the composition of the alloy core 110 is substantially the same with the composition of the aforementioned aluminum alloy powder, and based on the composition of the aluminum alloy powder 100, the native oxide layer 120 may include oxides of the metals in the aforementioned composition. In one embodiment, the main component of the native oxide layer 120 is aluminum oxide.

As shown in FIG. 1, the aluminum alloy powder 100 may further include alloy precipitates 130, and the alloy precipitates 130 are distributed mainly in the alloy core 110. The alloy precipitates 130 as a precipitate strengthening phase can increase the mechanical properties of the aluminum alloy powder 100.

As shown in FIG. 1, in some embodiments, a particle diameter D1 of the aluminum alloy powder 100 is about 2-65 μm, a thickness T1 of the native oxide layer 120 is about 5-10 nm. In one embodiment, the thickness T1 of the native oxide layer 120 is such as 5-7 nm.

In the embodiments of the present disclosure, aluminum is in an amount of about 83-87 wt % of the aluminum alloy powder. That is, in the composition of the aluminum alloy powder, in addition to Al, Si, Co, Mg, Ni and Mn with the above-mentioned weight percentages and other optional trace elements, the remainder is substantially Al.

In one embodiment, silicon is in an amount of about 8-10 wt % of the aluminum alloy powder.

In one embodiment, copper is in an amount of about 3-5 wt % of the aluminum alloy powder.

In the embodiments of the present disclosure, the aluminum alloy powder has relative high amount of Mg. In some embodiments, magnesium is in an amount of 0.4-1.5 wt % of the aluminum alloy powder, such that the mechanical properties and corrosion resistance of the aluminum alloy can be effective increased.

Further, the aluminum alloy powder has a relatively high amount of 8-10 wt % of Si together with a relatively high amount of 0.4-1.5 wt % of Mg, such that the Mg atoms and the Si atoms in the aluminum alloy can form magnesium silicide (Mg₂Si), which is a precipitate strengthening phase, e.g. alloy precipitates 130, in the aluminum alloy and can noticeably increase the mechanical strength at room temperature and wear resistance of the aluminum alloy, further effectively increasing the mechanical properties of the aluminum alloy.

Further, the aluminum alloy powder has a relatively high amount of 3-5 wt % of Cu, such that the Cu atoms and the Al atoms in the aluminum alloy can form copper-aluminum (Al₂Cu), and the Cu atoms, the Mg atoms and the Al atoms in the aluminum alloy can form copper-aluminum-magnesium (Al₂CuMg), which are both precipitate strengthening phase, e.g. alloy precipitates 130, in the aluminum alloy and can noticeably increase the mechanical strength at room temperature of the aluminum alloy, further effectively increasing the mechanical properties of the aluminum alloy.

In one embodiment, nickel is in an amount of about higher than 0 wt % to 1 wt % of the aluminum alloy powder. In one embodiment, manganese is in an amount of about higher than 0 wt % to 1 wt % of the aluminum alloy powder. In one embodiment, a combination of nickel and manganese is in an amount of about higher than 0 wt % to 1.5 w % of the aluminum alloy composition.

According to the embodiments of the present disclosure, the Ni atoms and the Al atoms in the aluminum alloy can form nickel-aluminum (Al₃Ni), and the Ni atoms, the Cu atoms and the Al atoms can form copper-nickel-aluminum (Al₃CuNi), which are both precipitate strengthening phase, e.g. alloy precipitates 130, in the aluminum alloy and can noticeably increase the mechanical strength of the aluminum alloy at high temperature, further effectively increasing the mechanical properties of the aluminum alloy at high temperature.

Further, the Mn atoms and the Al atoms in the aluminum alloy can form manganese-aluminum (Al₆Mn), and the Mn atoms, the Al atoms, the Si atoms and optionally trance amounts of iron atoms in the aluminum alloy can form silicon-iron-manganese-aluminum (AlMnFeSi), which are both precipitate strengthening phase, e.g. alloy precipitates 130, in the aluminum alloy and can noticeably increase the toughness of the aluminum alloy at high temperature, further effectively increasing the mechanical properties of the aluminum alloy at high temperature.

Moreover, according to the embodiments of the present disclosure, aluminum objects can be manufactured from the aluminum alloy powders by a laser additive manufacturing process. In comparison to manufacturing of aluminum alloy by a traditional casting process, of which the cooling rate of aluminum alloy is relatively slow, e.g. about 10^{1˜2}° C./s, the cooling rate of aluminum alloy manufactured by a laser additive manufacturing process is relatively fast, e.g. about 10^{3˜4}° C./s. Accordingly, adopting a laser additive manufacturing process along with the aluminum alloy powder of the present disclosure can increase the solid solubility of the strengthening elements, e.g. the alloy precipitate strengthening phase, in the aluminum alloy, make the microstructures of as-formed aluminum alloy objects have small grains and uniform microstructure, such that the physical properties and the mechanical properties of the aluminum alloy can be effectively increased.

In addition, according to the embodiments of the present disclosure, the aluminum alloy powder 100 has the native oxide layer 120. When a laser additive manufacturing process is adopted along with the aluminum alloy powder of the present disclosure, the native oxide layer 120 is crushed by high energy laser, and the oxide debris of the native oxide layer 120 is uniformly distributed in the melting pool formed from the aluminum alloy powder 100. After the aluminum alloy melting pool solidifies, the rapid solidification property from the laser additive manufacturing process makes it possible to control the particle size of the high-temperature strengthening phase, i.e. the oxide debris of the native oxide layer 120 and the aforementioned alloy strengthening phase, to be within micron size to sub-micron size. The oxide debris of the native oxide layer 120 can be uniformly distributed within the microstructure of the aluminum alloy object. These uniformly distributed oxide debris can effectively strengthen the structure of the aluminum alloy object and further increase the strength of the aluminum alloy object at high temperature.

According to the embodiments of the present disclosure, a manufacturing method of an aluminum alloy object is provided in the following. In some embodiments, the manufacturing method of the aluminum alloy object includes the following steps.

First, an aluminum alloy composition is provided. The aluminum alloy composition is basically the same as the composition of the aforementioned aluminum alloy powder. In some embodiments, the aluminum alloy composition includes 96.5-99 wt % of a combination of aluminum (Al), silicon (Si), copper (Cu) and magnesium (Mg) and the remainder including nickel (Ni) and manganese (Mn).

In one embodiment, aluminum is in an amount of about 83-87 wt % of the aluminum alloy composition. In one embodiment, silicon is in an amount of about 8-10 wt % of the aluminum alloy composition. In one embodiment, copper is in an amount of about 3-5 wt % of the aluminum alloy composition. In one embodiment, magnesium is in an amount of about 0.4-1.5 wt % of the aluminum alloy composition. In one embodiment, nickel is in an amount of about higher than 0 wt % to 1 wt % of the aluminum alloy composition. In one embodiment, manganese is in an amount of about higher than 0 wt % to 1 wt % of the aluminum alloy composition. In one embodiment, a combination of nickel and manganese is in an amount of about higher than 0 wt % to 1.5 wt % of the aluminum alloy composition.

Next, a gas atomization process is performed on the aluminum alloy composition for forming a plurality of aluminum alloy powders 100, and each of the aluminum alloy powders 100 includes an aforementioned alloy core 110 and an aforementioned native oxide layer 120 covering the alloy core 110. The aluminum alloy powder 100 may further include alloy precipitates 130.

Specifically speaking, the material of the aluminum alloy composition is prepared according to the aforementioned elements and weight percentages, and the prepared material is melted and refined to obtain an aluminum alloy block. Next, the aluminum alloy block is melted into aluminum alloy solution at high temperature followed by performing a gas atomization process for forming the aluminum alloy powders 100.

In some embodiments, the gas atomization process includes a vacuum induction melting gas atomization (VIGA) process. In some embodiments, a particle diameter of the aluminum alloy powder 100 is about 2-65 μm. For example, the average particle diameter D₅₀ of the aluminum alloy powder 100 is about 25-35 μm.

In some embodiments, a gas atomization pressure of the gas atomization process is such as 25-45 bars, and a gas flow rate of the gas atomization process is such as 8.5-11.0 m³/min.

Next, a heating treatment is performed on the aluminum alloy powders 100. The heating treatments further oxidize the aluminum alloy powders 100, resulting in an increase of the thickness of the native oxide layer 120. For example, the thickness of the native oxide layer 120 of the aluminum alloy powder 100 formed by the gas atomization process is such as 3-4 nm. After the heating treatment, the thickness of the native oxide layer 120 is increased to be at least 5 nm or even thicker.

In some embodiments, a heating temperature of the heating treatment is such as about 200-400° C., and the heating time of the heating treatment is such as about 2-4 hours.

Next, a laser additive manufacturing (AM) process is performed on the aluminum alloy powders for forming an aluminum alloy object. In the embodiment, performing the heating treatment is prior to performing the laser additive manufacturing process. In some embodiments, performing the laser additive manufacturing process may include such as performing a laser sintering process on the aluminum alloy powders 100, wherein a heating temperature of the laser sintering process is such as about 660-2400° C.

FIGS. 2-3 show a laser additive manufacturing process according to an embodiment of the present disclosure. As shown in FIG. 2, when a laser 200 is applied on the aluminum alloy powders 100, as shown in the enlarged drawing, the aluminum alloy powders 100 are melted and turn into a melting pool by heating. Due to the stirring, as shown by the liquid flows F1, the oxide debris 140 of the native oxide layer 120 is uniformly distributed in the melting pool along with the liquid flows F1.

Next, as shown in FIG. 3, the melting pool is cooled down to form the aluminum alloy object 300. The rapid solidification property of the laser additive manufacturing process can refine the structure of the aluminum alloy object; further, due to the uniformly distributed oxide debris 140, the refined structure of the aluminum alloy object 300 can be further strengthened, and the mechanical properties of the aluminum alloy object 300 at high temperature can be further increased. Specifically speaking, as shown in the enlarged drawing of FIG. 3, in the microstructure of the aluminum alloy object 300, the oxide precipitates 130 and the oxide debris 140 are uniformly distributed between the grain boundaries 310 and on the grain boundaries 310, such that the overall mechanical properties of the aluminum alloy object 300 at high temperature can be uniformly increased.

Next, an aging heating treatment can be optionally performed on the aluminum alloy object. In some embodiments, the heating temperature of the aging heating treatment is such as 150-175° C., and the heating time is such as 6-8 hours.

Further explanation is provided with the following examples. Compositions of aluminum alloy powders and test results of properties of the aluminum alloy objects made of the compositions of some examples are listed for showing the properties of aluminum alloy powders according to the embodiments of the disclosure. However, the following examples are for purposes of describing particular embodiments only, and are not intended to be limiting.

The manufacturing processes of the aluminum alloy powders of embodiments 1-3 are as follows.

The aluminum alloy materials prepared according to the compositions and weight percentages as shown in table 1 are melted and refined in a high-temperature fusion furnace and then casted into pellets. Next, 6000-6500 grams of the aluminum alloy pellets are melted and placed in an induction melting graphite crucible of a gas atomization apparatus. After the apparatus is airtight closed, vacuum air extraction is performed to achieve an interior pressure of 3.0˜5.0*10⁻⁴ torr, and the atomization thermal insulation crucible is heated to 650800° C. Next, the induction melting is on for performing a high frequency induction re-melting process. After the temperature of the aluminum alloy solution reaches 650800° C., the gas atomization process is performed for forming the alloy powders with an inert gas atomization pressure of 25-45 bars and a gas flow rate of 8.5-11.0 m³/min. After the powders are cooled and collected, the powders are sieved. Next, a heating treatment is performed on the powders with a heating temperature of 200400° C. and a heating time of 2-4 hours, and an atmosphere heating furnace is used.

Next, after the powders are sieved, heated and gas atomized, microscopic pictures of the powders are observed. Then, the particle diameters are analyzed by a laser particle diameter analyzer, the obtained average particle diameter D₅₀ is 25-30 μm, indicating the powders are suitable for laser additive manufacturing.

Finally, the sintered and shaped object made by the laser additive manufacturing process is observed with an electronic microscope, and tests of tension properties of the shaped samples are measured.

The compositions of the aluminum alloy powders and the test results of properties of the aluminum alloy objects of each of the embodiments and comparative embodiments are listed in tables 1-2, wherein the ratios of each of the elements are represented as the weight percentages with respect to the aluminum alloy powder.

In table 1, in each of the compositions of embodiments and comparative embodiments, in addition to the elements (e.g. Si, Cu, Mg, Ni, Mn . . . etc.) and the corresponding weight percentages listed in the table, the remainder of the composition is substantially Al represented by “bal.” It is to be noted that one of ordinary skill in the art understands that based on the raw materials of each of the elements selected and used, the as-made compositions may contain trace amounts of impurity elements other than the pre-determined and designed elements with pre-determined weight ratios, and these impurity elements may be originally existed in the raw materials.

TABLE 1

| Embodiment | Al | Si | Cu | Mg | Ni | Mn |
|---|---|---|---|---|---|---|
| 1 | bal. | 9 | 3.5 | 0.5 | 0.5 | 1.0 |
| 2 | bal. | 9 | 4.0 | 0.9 | 0.75 | 0.75 |
| 3 | bal. | 9 | 4.5 | 1.3 | 1.0 | 0.5 |

The aluminum alloy powders 100 made according to the compositions and weight percentages listed in table 1 are spherical with smooth surfaces. After a further heating treatment, the thickness of the native oxide layer 120 is increased from about 4 nm to about 6 nm.

In table 2, embodiments 1-2 and 1-4, embodiments 2-2 and embodiments 2-4 and 3-2 and 3-4 are aluminum alloy objects made from aluminum alloy powders with compositions of embodiments 1, 2 and 3, respectively, and by an inner gas spraying process, a heating treatments and a laser sintering process sequentially. Moreover, embodiments 1-1 and 1-3, embodiments 2-1 and embodiments 2-3 and 3-1 and 3-3 are aluminum alloy objects made from aluminum alloy powders with compositions of embodiments 1, 2 and 3, respectively, and by a traditional casting process.

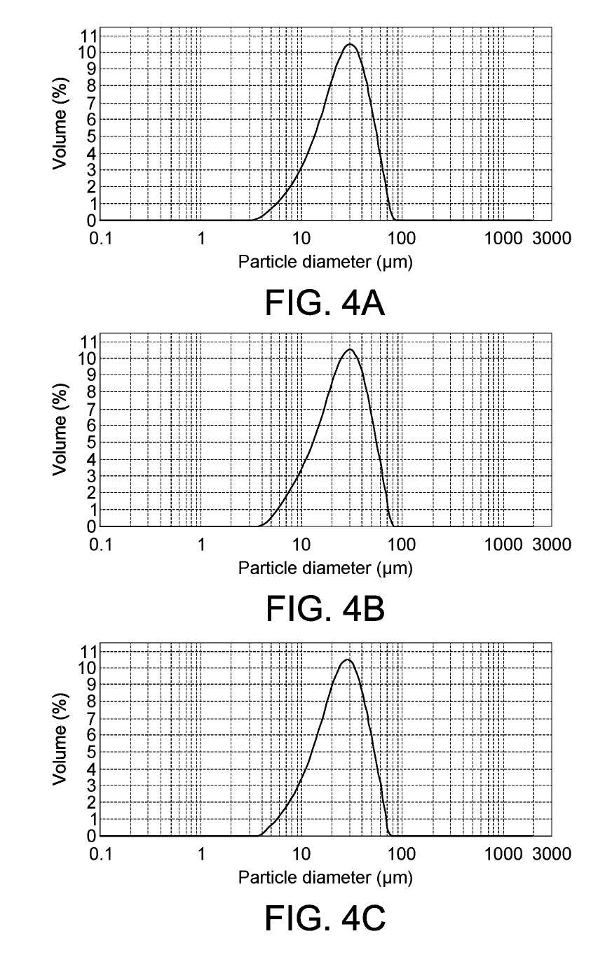

The aluminum alloy powders formed from embodiments 1-3 by gas atomization processes have average particle diameter D₅₀ as shown in FIGS. 4A, 4B and 4C, respectively.

In table 2, the results of the yielding strength (YS), the tensile strength (UTS), and the elongation percentage (EL) are measured from the aluminum alloy powders after performed with an inert gas spraying process, a heating treatment and a laser sintering process. The above results are measured by Gleeble3500. In table 2, the results of embodiments 1-1 and 1-2, embodiments 2-1 and 2-2, and embodiments 3-1 and 3-2 are measured at room temperature (25° C.), and the results of embodiments 1-3 and 1-4, embodiments 2-3 and 2-4, and embodiments 3-3 and 3-4 are measured at 250° C.

TABLE 2

| | Yielding | Tensile | Elongation |
|---|---|---|---|
| Embodiment | strength (YS) | strength (UTS) | percentage (EL) |
| 1-1 (25° C.) | 156 MPa | 329 MPa | 3.2% |
| 1-2 (25° C./AM) | 257 MPa | 411 MPa | 13.7% |
| 1-3 (250° C.) | 129 MPa | 143 MPa | 4.2% |
| 1-4 (250° C./AM) | 177 MPa | 190 MPa | 9.7% |
| 2-1 (25° C.) | 188 MPa | 336 MPa | 2.7% |
| 2-2 (25° C./AM) | 284 MPa | 421 MPa | 8.8% |
| 2-3 (250° C.) | 151 MPa | 176 MPa | 3.3% |
| 2-4 (250° C./AM) | 179 MPa | 193 MPa | 7.2% |
| 3-1 (25° C.) | 191 MPa | 358 MPa | 1.3% |
| 3-2 (25° C./AM) | 247 MPa | 403 MPa | 8.3% |
| 3-3 (250° C.) | 153 MPa | 177 MPa | 2.7% |
| 3-4 (250° C./AM) | 178 MPa | 217 MPa | 6.8% |

As shown in FIG. 2, in the samples of embodiments 1-1 to 3-4, compared to the aluminum alloy objects made by a traditional casting process, the aluminum alloy objects made from the aluminum alloy powders according to the embodiments of the present disclosure and by a laser additive manufacturing process can have better mechanical properties not only at room temperature but also at high temperature.

In summary, according to the embodiments of the present disclosure, the aluminum alloy powder includes an alloy core and a native oxide layer covering the alloy core, such that when the native oxide layer is crushed by the high energy laser from the laser additive manufacturing process, the oxide debris of the native oxide layer is uniformly distributed within the microstructure of the aluminum alloy object, such that the structure of the aluminum alloy object can be effectively strengthened.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An aluminum alloy powder, comprising:
96.5-99 wt % of a combination of aluminum (Al), silicon (Si), copper (Cu) and magnesium (Mg); and
the remainder comprising nickel (Ni) and manganese (Mn);
wherein the aluminum alloy powder comprises an alloy core and a native oxide layer covering the alloy core.

2. The aluminum alloy powder according to claim 1, wherein a particle diameter of the aluminum alloy powder is 2-65 μm, and a thickness of the native oxide layer is 5-10 nm.

3. The aluminum alloy powder according to claim 2, where the thickness of the native oxide layer is 5-7 nm.

4. The aluminum alloy powder according to claim 1, wherein aluminum is in an amount of 83-87 wt % of the aluminum alloy powder.

5. The aluminum alloy powder according to claim 1, wherein silicon is in an amount of 8-10 wt % of the aluminum alloy powder.

6. The aluminum alloy powder according to claim 1, wherein copper is in an amount of 3-5 wt % of the aluminum alloy powder.

7. The aluminum alloy powder according to claim 1, wherein magnesium is in an amount of 0.4-1.5 wt % of the aluminum alloy powder.

8. The aluminum alloy powder according to claim 1, wherein nickel is in an amount of higher than 0 wt % to 1 wt % of the aluminum alloy powder.

9. The aluminum alloy powder according to claim 1, wherein manganese is in an amount of higher than 0 wt % to 1 wt % of the aluminum alloy powder.

10. A manufacturing method of an aluminum alloy object, comprising:
providing an aluminum alloy composition; comprising:
96.5-99 wt % of a combination of aluminum (Al), silicon (Si), copper (Cu) and magnesium (Mg); and
the remainder comprising nickel (Ni) and manganese (Mn);
performing a gas atomization process on the aluminum alloy composition for forming a plurality of aluminum alloy powders, each of the aluminum alloy powders comprising an alloy core and a native oxide layer covering the alloy core;
performing a heating treatment on the aluminum alloy powders; and
performing a laser additive manufacturing (AM) process on the aluminum alloy powders for forming an aluminum alloy object.

11. The manufacturing method of the aluminum alloy object according to claim 10, wherein the gas atomization process comprises a vacuum induction melting gas atomization (VIGA) process.

12. The manufacturing method of the aluminum alloy object according to claim 10, wherein a gas atomization pressure of the gas atomization process is 25-45 bars, and a gas flow rate of the gas atomization process is 8.5-11.0 m³/min.

13. The manufacturing method of the aluminum alloy object according to claim 10, wherein a heating temperature of the heating treatment is 200-400° C., and the heating time of the heating treatment is 2-4 hours.

14. The manufacturing method of the aluminum alloy object according to claim 10, wherein performing the heating treatment is prior to performing the laser additive manufacturing process.

15. The manufacturing method of the aluminum alloy object according to claim 10, wherein performing the laser additive manufacturing process comprises:
performing a laser sintering process on the aluminum alloy powders, wherein a heating temperature of the laser sintering process is 660-2400° C.

16. The manufacturing method of the aluminum alloy object according to claim 10, wherein a particle diameter of the aluminum alloy powders is 2-65 μm, and a thickness of each of the native oxide layers is 5-10 nm.

17. The manufacturing method of the aluminum alloy object according to claim 10, wherein silicon is in an amount of 8-10 wt % of the aluminum alloy composition.

18. The manufacturing method of the aluminum alloy object according to claim 10, wherein copper is in an amount of 3-5 wt % of the aluminum alloy composition.

19. The manufacturing method of the aluminum alloy object according to claim 10, wherein magnesium is in an amount of 0.4-1.5 wt % of the aluminum alloy composition.

20. The manufacturing method of the aluminum alloy object according to claim 10, wherein a combination of nickel and manganese is in an amount of higher than 0 wt % to 1.5 wt % of the aluminum alloy composition.
